(19) United States
(12) Patent Application Publication
(10) Pub. No.: US 2006/0226049 A1
(43) Pub. Date: Oct. 12, 2006

(54) Oxidative desulfurization of hydrocarbon fuels

(76) Inventors: Laszlo T. Nemeth, Barrington, IL (US); Anil R. Oroskar, Oakbrook, IL (US); Kurt M. Vanden Bussche, Lake in the Hills, IL (US); Franz-Marcus Nowak, Arlington Heights, IL (US); Matthew J. Schmidt, Des Plaines, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 11/101,731

(22) Filed: Apr. 8, 2005

(51) Int. Cl. C10G 45/00; B01J 8/02; B01J 35/02

(52) U.S. Cl. 208/208 R; 422/211

(57) ABSTRACT

A process and apparatus for the desulfurization of hydrocarbon fuels is presented. The apparatus and process use an inorganic metal peroxide and catalyst to oxidize the sulfur compounds. The oxidized sulfur compounds are then adsorbed on an adsorbent.

### FIELD OF THE INVENTION

This invention relates to a process and apparatus for the removal of sulfur containing compounds from fuels.

### BACKGROUND OF THE INVENTION

There is increasing demand to improve products that have an effect on environmental conditions. Included in those products is a demand for fuels having a very low sulfur content to reduce the amount of sulfur dioxide when the fuel is combusted. Fuels containing residual amounts of sulfur compounds need to have a further reduction of the remaining sulfur compounds.

Traditionally, hydrocarbons containing sulfur have been subjected to a catalytic hydrogenation zone to remove sulfur and produce hydrocarbons having lower concentrations of sulfur. Hydrogenation to remove sulfur is very successful for the removal of the sulfur from hydrocarbons that have sulfur components that are easily accessible to contact with the hydrogenation catalyst. However, the removal of sulfur components which are sterically hindered becomes exceedingly difficult and therefore the removal of sulfur components to a sulfur level below about 100 ppm is very costly by known current hydrotreating techniques. It is also known that a hydrocarbonaceous oil containing sulfur may be subjected to oxygenation to convert the hydrocarbonaceous sulfur compounds to compounds containing sulfur and oxygen, such as sulfoxide or sulfone for example, which have different chemical and physical characteristics which make it possible to isolate or separate the sulfur-bearing compounds from the balance of the original hydrocarbonaceous oil. For example, see a paper presented at the 207th American Chemical Society Meeting in San Diego, Calif. on Mar. 13-17, 1994 entitled “Oxidative Desulfurization of Liquid Fuels” by Tetsuo Aida et al. The disadvantage to this approach is that the process requires further liquid separation techniques, such as distillation or the use of liquid solvents, which further requires additional separation processes and therefore is uneconomic.

### SUMMARY OF THE INVENTION

The present invention provides a method and apparatus for reducing sulfur content in fuels. In one embodiment, the invention comprises contacting the fuel with an oxidizing agent made of a metal peroxide and a catalyst to form an oxidized sulfur compound that can be separated from the fuel. One aspect of the invention involves removing the oxidized sulfur product by adsorbing the oxidized sulfur compound on an adsorbent. This invention can be used to treat fuels that have already been treated to reduce the sulfur in the fuel.

In another embodiment, the invention comprises an apparatus for removing sulfur from a fuel stream. The apparatus can be inserted into a fuel line to treat the fuel as it is transferred to a fuel tank, or as it transfers from a fuel tank to an engine. The apparatus comprises a closed vessel with an inlet line for the untreated fuel to enter and an outlet line for the treated fuel to exit. The fuel flows through a first section of the vessel contacting a solid metal peroxide and catalyst for reacting the sulfur compounds to produce oxidized sulfur products. The fuel then flows through a second section comprising an adsorbent for removing the oxidized sulfur products. The adsorbents are chosen such that there is a preferential adsorption of polar sulfones.

Additional objects, embodiments and details of this invention can be obtained from the following detailed description of the invention.

### BRIEF DESCRIPTION OF THE DRAWINGS

FIG. 1 is a diagram of the use of the apparatus for reducing sulfur in fuel;

FIG. 2 is a diagram of an alternate embodiment of the use of the apparatus for reducing sulfur in fuel;

FIG. 3 is a diagram of the use of the apparatus in an engine system with exhaust gas recycle; and

FIG. 4 is a diagram of an alternate embodiment with exhaust gas recycle.

### DETAILED DESCRIPTION OF THE INVENTION

The reduction of sulfur in fuels is of increasing importance in response to environmental concerns. A common method for reducing sulfur in hydrocarbon based fuels is through hydro-desulfurization, or hydrotreating, as shown in U.S. Pat. No. 6,171,478 B1 and U.S. Pat No. 5 6,277,271 B1, issued Jun. 9, 2001 and Aug. 21, 2001 respectively, and which are incorporated by reference in their entireties. The reduction of sulfur compounds is also achieved through using catalysts in oxidation states above zero as shown in U.S. Pat. No. 6,846,403 B1 issued Jan. 25, 2005. However, hydrotreating and the reduction of sulfur is useful for removing many sulfur compounds, yet these methods have difficulty removing large substituted thiophenic compounds, e.g. substituted dibenzothiophenes, and subsequently have difficulty reducing the amount of sulfur to ultralow levels that are required by legislation.

The present invention comprises the process of selective oxidation of sulfur compounds in a hydrocarbon fuel. The process comprises contacting the hydrocarbon fuel containing sulfur compounds with an inorganic metal peroxide and catalyst to oxidize the sulfur compounds to an oxidized sulfur compound. In particular, the sulfur compounds are thiophene compounds that are converted to sulfone compounds. The sulfone compounds are polar compounds that are more easily removed from the hydrocarbon stream.

The metal peroxides are strong oxidizing agents that preferentially oxidize thiophene compounds in the presence of a catalyst. The thiophenes are oxidized to polar sulfone compounds, and the sulfone compounds can be removed from the fuel. Preferably, the metals in the metal peroxides used for the oxidation of the sulfur compounds in the hydrocarbon fuel include alkaline earth metals, and which are barium, strontium, calcium, magnesium and beryllium. Preferred metals include barium, calcium, and magnesium. It is preferred that the metal peroxide is supported on a solid support, and remains in an oxidation unit as the fuel passes through the oxidation unit.

The oxidation is performed in the presence of a catalyst. The oxidant is a solid and is intermingled with the catalyst to provide the appropriate proximity for the oxidation reaction to take place. The metal peroxide can be supported on the same support as the catalyst, or can be physically mixed with the catalyst as a mixture of small particles.

Catalysts for the present invention include metals supported on high surface area inorganic oxides, zeolites, molecular sieves, carbon, or the like. High surface area materials include, but are not limited to, silica, alumina, silica-alumina, titania, zirconia, silicon carbide, and diatomaceous earth. It should be noted the term silica-alumina does not mean a physical mixture of silica and alumina but means an acidic amorphous material that has been cogelled or coprecipitated. The term is well known in the art and is described, for example, in U.S. Pat. No. 3,909,450; U.S. Pat. No. 3,274,124 and U.S. Pat. No. 4,988,659. In this respect, it is possible to form other cogelled or coprecipitated materials that will also be effective. Examples include, but are not limited to silica-zirconias, silica-titania, silica-alumina-zirconias, and mixtures of these, and the like.

The metals in the catalysts include transition metals and tin (Sn) and indium (In). The transition metals include all metals in IUPAC groups 3-12 of the Periodic Table (groups IIIB, IVB, VB, VIB, VIIB, VIII, IB and IIB), which includes scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lanthanum (La), hafnium (Hf), tantalum (Ta), tungsten (W), rhenium (Re), osmium (Os), iridium (Ir), platinum (Pt), gold (Au), and mercury (Hg). Preferred metals for the catalyst include titanium (Ti), iron (Fe), vanadium (V), manganese (Mn), molybdenum (Mo), chromium (Cr), and nickel (Ni). Preferably, the metals in the catalysts are selected from the group comprising titanium, iron, vanadium, manganese, molybdenum, chromium, and nickel.

The catalyst metals are dispersed on supports including carbon, metal oxides, mixed metal oxides, molecular sieves, zeolites, and the like.

The metal peroxide reacts with the sulfur compounds and produces a spent metal oxide as a by-product. This spent metal oxide can be further used to react and remove carbon dioxide that is produced upon combustion of the fuel. The carbon dioxide reacts with the metal oxide to form an inert metal carbonate. The conversion of the metal oxide to a metal carbonate changes the spent oxidant to a water insoluble material. The metal carbonate can be disposed of conveniently, or can be processed to regenerate the metal peroxide for subsequent use.

The metal carbonate can be regenerated by first forming the metal oxide, and in particular barium oxide. The metal oxide is formed by decomposing the metal carbonate to the metal oxide and carbon dioxide. Typical methods for decomposition include applying heat to the metal carbonate. Barium oxide is transformed back to barium peroxide by flowing air, or oxygen, over the barium oxide at a temperature between 400° C. and 600° C., and preferably between 450° C. and 500° C.

In one embodiment, the invention comprises an adsorbent for adsorbing the polar sulfone compounds. Adsorbents for adsorbing the polar sulfone compounds include, but are not limited to, zeolites, molecular sieves, high surface area carbons, and the like. The adsorbents can be disposed in a separate bed of adsorbent, or in the alternative, can be intermingled with the oxidant and catalyst in the same bed.

Examples of adsorbents include, but are not limited to, zeolites, molecular sieves, inorganic oxides, and high surface area carbons. Among the inorganic oxides, alumina, silica, and silica-alumina are preferred. The adsorbents used should selectively adsorb polar sulfone compounds.

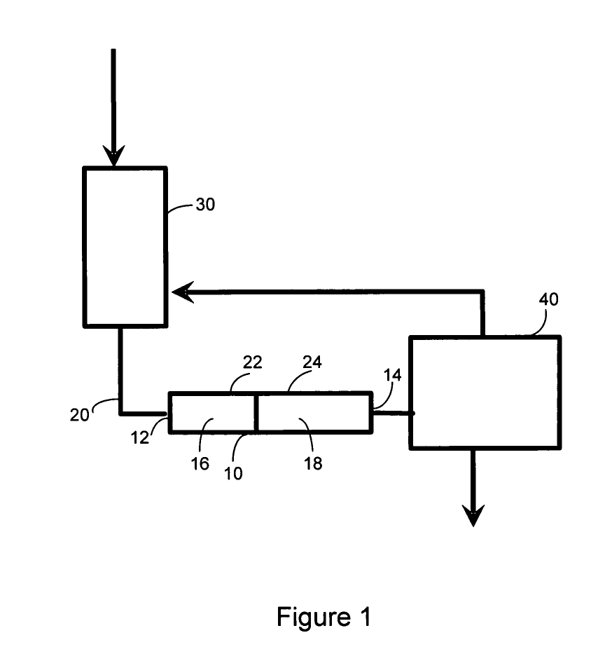

The invention further includes an apparatus for insertion into a fuel system, as shown in FIG. 1. The apparatus includes a container 10 for insertion in a fuel line 20. The container has an inlet 12 for admitting untreated fuel, and an outlet 14 for the egress of treated fuel. The fuel flows through a compartment and over a bed 16 of solid oxidizing agent and catalyst disposed within the bed, producing a fuel with oxidized sulfur compounds. The fuel with oxidized sulfur compounds flows over an adsorbent 18 that adsorbs the oxidized sulfur compounds and produces a fuel with a reduced sulfur content. In a preferred embodiment, the container is made up of two sections, a first section 22 holding the oxidant and catalyst for oxidizing the sulfur compounds, and a second section 24 holding the adsorbent for removing the oxidized sulfur compounds. In an alternate embodiment, the adsorbent is mixed with the oxidant and catalyst in a single compartment.

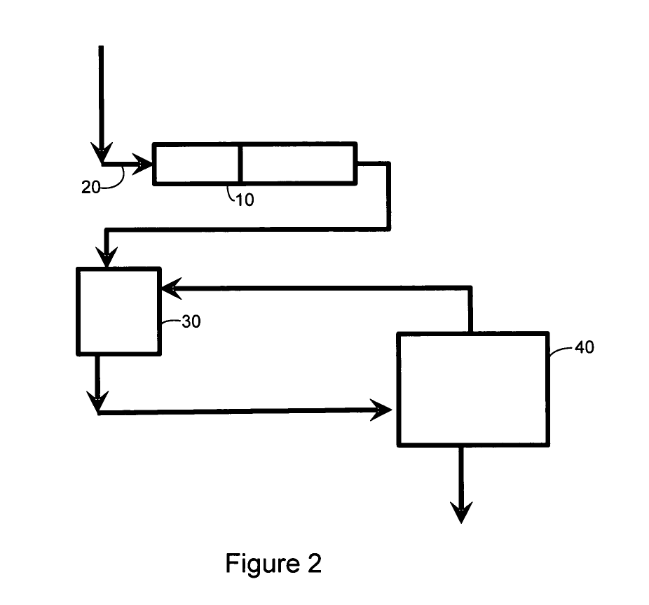

The positioning of the apparatus 10 can be between a fuel tank 30 and an end use, such as an engine 40, as shown in FIG. 1, or in an alternative, the fuel can be treated prior to entering the fuel tank 30, as shown in FIG. 2. The choice of positioning of the apparatus 10 is based on numerous factors. Among the factors include the rate of usage of fuel from the fuel tank 30; product degradation from treating the fuel; retrofitting of equipment, such as vehicles, to accept the apparatus 10; and whether it is easier to fit the apparatus 10 to a fuel delivery device rather than a machine that is using the fuel, wherein the fuel is treated prior to delivery of the fuel to the fuel tank 30.

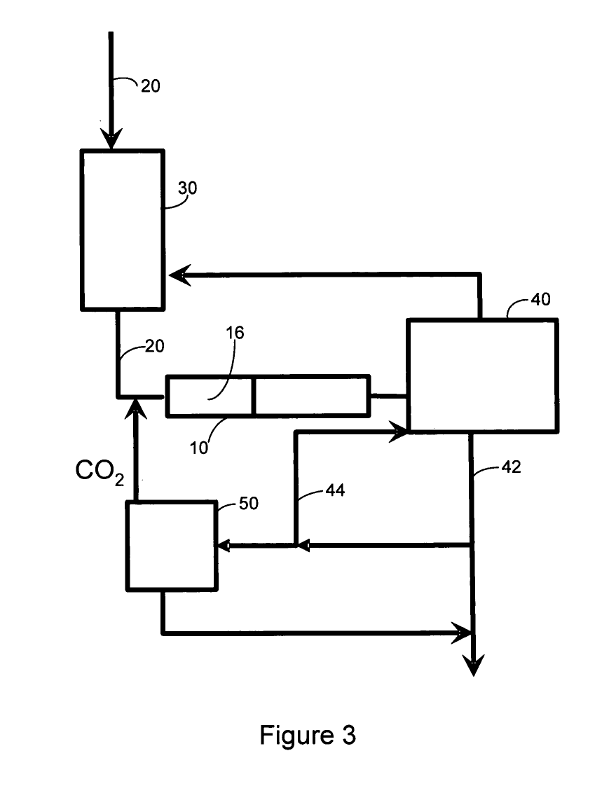

The treatment of fuel is especially applicable to the treatment of diesel fuel to produce an ultralow sulfur diesel (USD) fuel. One design of diesel engines involves exhaust gas recycle (EGR) to reduce NOx emissions. The recycle of exhaust gas brings with it carbon dioxide (CO₂). When the choice of metal for the metal peroxide is barium, there are environmental concerns as barium is known as a hazardous material. A portion of the carbon dioxide in the recycle gas can be separated and fed to the apparatus 10 as a separate feed to convert barium oxide (BaO) to barium carbonate (BaCO₃). Barium carbonate is a stable form of a barium compound and has a low solubility, and is easier to contain and recover to prevent the loss of barium into the environment. A diagram of one embodiment is shown in FIG. 3, where the apparatus 10 is positioned in a fuel line 20 between a fuel tank 30 and an engine 40. The engine 40 generates an exhaust that is passed through an exhaust line 42. A portion of the exhaust is recycled through a recycle line 44, while another portion of the exhaust is passed through a separator 50 to recover carbon dioxide. The carbon dioxide is passed to the apparatus 10 and passes over the oxidant bed 16 where the spent metal oxide combines to form metal carbonate. This produces a spent product that has lower solubility and reduces chances of environmental contamination.

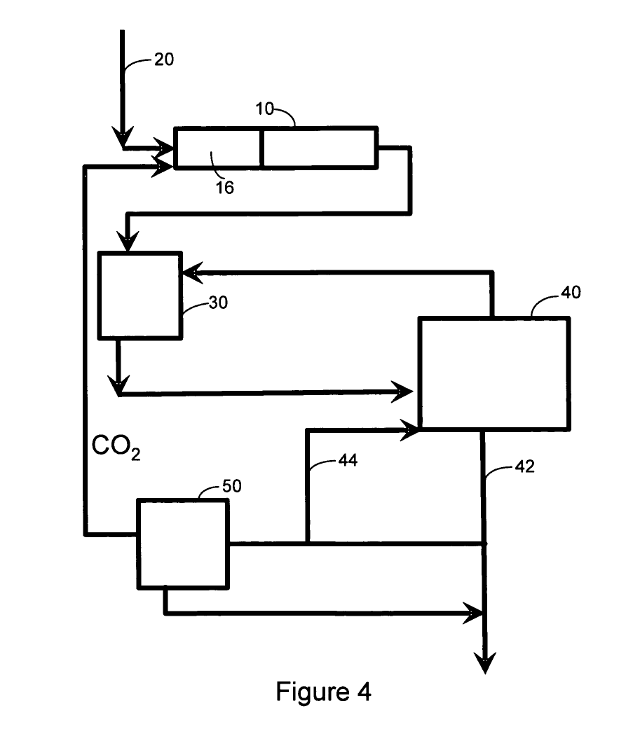

In another embodiment, as shown in FIG. 4, the apparatus 10 is positioned before the fuel tank 30, for treatment of the fuel as the tank 30 is being filled. The engine 40 has an exhaust gas recycle, where a portion of the exhaust is directed to a separation unit 50 for the separation of carbon dioxide. The recovered carbon dioxide is passed to the apparatus 10 and passed over the oxidant and catalyst bed 16 where the spent metal oxide becomes metal carbonate.

A variation of the embodiments with the apparatus 10 positioned before the fuel tank 30 is the attachment of the apparatus 10 to a fuel dispensing station (not shown). This provides for on-site retrofitting of either refineries, or gas stations, as they dispense diesel fuel, to produce an ultralow diesel fuel, while providing a centralized and stationary fuel treatment facility.

### EXAMPLE

A hydrocarbon stream comprising 100 ppm of dibenzothiophene in hexane was contacted with barium oxide (BaO₂) as an oxidant at 50° C. for 8 hours. Several experiments were carried out with the oxidant (BaO₂) and in the presence or absence of a catalyst. The hydrocarbon stream had a reduction in the amount of dibenzothiophene as shown in Table 1. It was found that a catalyst and oxidant significantly reduced the sulfur compounds that are left behind during a hydrotreating process. In the particular experiments, the catalysts used include titanium impregnated molecular sieves such as silicalite and MCM-41. The oxidant was also tested in combination with water and sulfuric acid for enhancing the oxidation of the dibenzothiophene.

TABLE 1
Oxidation of Dibenzothiophene with BaO₂

| Catalyst | Oxidant | Conversion, % |
|---|---|---|
| None | BaO₂ | 0 |
| Ti-MCM-41 | BaO₂ + H₂O | 5.6 |
| Ti silicalite | BaO₂ + H₂O | 0 |
| Ti-MCM-41 | BaO₂ + H₂SO₄ | 60 |
| Ti silicalite | BaO₂ + H₂SO₄ | 37 |

The experiments showed a substantial conversion of the dibenzothiophene to a sulfone in the presence of an inorganic metal peroxide and catalyst.

Further experiments were performed to study the removal of the oxidized sulfur compounds. The polar sulfone was adsorbed onto an adsorbent and removed from the hexane stream. The experimental conditions included contacting a hexane stream having 100 ppm dibenzothiophene with barium peroxide at 60° C. for 8 hours. The adsorbent used in the experiments was a silica gel.

TABLE 2
Oxidation of Dibenzothiophene

| | | | Adsorbed sulfone, |
|---|---|---|---|
| Catalyst | Oxidant | Conversion, % | % |
| Ti-MCM-41 | BaO₂ + H₂O + CO₂ | 100 | 58 |
| | (100 psig) | | |
| Ti-MCM-41 | BaO₂ + H₂O + CO₂ | 100 | 57 |
| | (atm) | | |

Further oxidative desulfurization experiments were performed using barium peroxide as the oxidant with Ti-MCM-41 catalyst to oxidize Ultra Low Sulfur Diesel (ULSD). The sulfur was removed to a concentration of less than 1 ppm level in the diesel. The experiments comprised mixing ULSD, barium peroxide and catalyst in a 300 cc PARR autoclave. The reaction vessel was heated to 60° C. for 14 hours with carbon dioxide, and without carbon dioxide. After reacting the ULSD and the oxidant, the mixture was filtered and the ULSD was passed through a silica gel cartridge to adsorb the sulfone onto the silica gel. The sulfur concentration of the feed and treated samples were measured by Sulfur XRF, with the results shown in Table 3. There was more than 75% removal of the sulfur from the ULSD leaving a concentration of less than 1 ppm sulfur in the treated ULSD.

TABLE 3
Oxidation of ULSD with BaO₂

| | BaO₂/S mol | CO₂ pressure | S (ppm after | % S |
|---|---|---|---|---|
| Test | ratio | (psig) | adsorption) | removal |
| 1 | 4 | 100 | <1 | >75 |
| 2 | 10 | 100 | <1 | >75 |
| 3 | 25 | 100 | <1 | >75 |
| 4 | 50 | 100 | <1 | >75 |
| 5 | 4 | no CO₂ | <1 | >75 |
| 6 | 10 | no CO₂ | <1 | >75 |
| 7 | 25 | no CO₂ | <1 | >75 |

The present invention has demonstrated the oxidation and adsorption of sulfur compounds from hydrocarbon fuels through the use of metal peroxides and catalysts.

While the invention has been described with what are presently considered the preferred embodiments, it is to be understood that the invention is not limited to the disclosed embodiments, but it is intended to cover various modifications and equivalent arrangements included within the scope of the appended claims.

What is claimed is:

1. A process for the desulfurization of hydrocarbon streams comprising:
contacting a hydrocarbon stream comprising compounds containing sulfur with an oxidizing compound comprising an inorganic metal peroxide and catalyst at reaction conditions generating an effluent stream containing an oxidized organic sulfur product; and
separating at least a portion of the oxidized sulfur product from the treated hydrocarbon stream.

2. The process of claim 1 wherein the oxidized sulfur product is adsorbed on an adsorbent.

3. The process of claim 1 wherein the metal in the metal peroxide is selected from the group consisting of barium, strontium, calcium, magnesium, beryllium, and mixtures thereof.

4. The process of claim 1 wherein the metal peroxide is supported on the solid catalyst or in a physical mixture with the solid catalyst.

5. The process of claim 1 wherein the oxidized sulfur product comprises a sulfone.

6. The process of claim 4 wherein the adsorbent is selected from the group consisting of zeolites, molecular sieves, inorganic oxides, carbon, and mixtures thereof.

7. The process of claim 1 wherein the metal peroxide after oxidizing the sulfur compound forms a spent metal oxide, further comprising treating the spent metal oxide with carbon dioxide to form a metal carbonate.

8. The process of claim 7 wherein the carbon dioxide used to form the metal carbonate is recycled from an exhaust stream from an engine consuming the hydrocarbon stream.

9. The process of claim 1 wherein the catalyst comprises a metal on a solid support, wherein the metal is selected from the group consisting of transition metals, tin, indium and mixtures thereof.

10. The process of claim 9 wherein the transition metal is selected from the group consisting of titanium (Ti), iron (Fe), vanadium (V), manganese (Mn), molybdenum (Mo), chromium (Cr), nickel (Ni), and mixtures thereof.

11. The process of claim 9 wherein the solid support is selected from the group consisting of molecular sieves, zeolites, carbon, inorganic oxides, and mixtures thereof.

12. An apparatus for use in desulfurizing fuels comprising:
a container having an inlet in fluid communication with a fuel line, an outlet, and a compartment wherein the fuel flows through from the inlet to the outlet; and
a solid oxidizing agent and a catalyst for oxidizing sulfur compounds in the fuel to generate an oxidized sulfur product, and an adsorbent for adsorbing the oxidized sulfur product, wherein the oxidizing agent, catalyst and adsorbent are disposed in the compartment.

13. The apparatus of claim 12 wherein the compartment is divided into a first and second section, and wherein the fuel flows through the first and second section from the inlet to the outlet, and where the solid oxidizing agent and catalyst are disposed in the first section and the adsorbent is disposed in the second section.

14. The apparatus of claim 12 wherein the solid oxidizing agent, catalyst and adsorbent are physically mixed.

15. The apparatus of claim 12 wherein the solid oxidizing agent comprises a metal peroxide.

16. The apparatus of claim 15 wherein the metal is selected from the group consisting of barium, strontium, calcium, magnesium, beryllium, and mixtures thereof.

17. The apparatus of claim 16 wherein the oxidizing agent comprises barium peroxide (BaO₂).

18. The apparatus of claim 12 wherein the solid catalyst comprises a metal on a solid support, wherein the metal is selected from the group consisting of transition metals, tin, indium and mixtures thereof.

19. The apparatus of claim 18 wherein the transition metal is selected from the group consisting of titanium (Ti), iron (Fe), vanadium (V), manganese (Mn), molybdenum (Mo), chromium (Cr), nickel (Ni), and mixtures thereof.

20. The apparatus of claim 18 wherein the solid support is selected from the group consisting of molecular sieves, zeolites, carbon, inorganic oxides, and mixtures thereof.

21. The apparatus of claim 12 wherein the apparatus is disposed between a fuel tank and an engine.

22. The apparatus of claim 12 wherein the apparatus is disposed in a fuel line to a fuel tank where the fuel is treated before entering the fuel tank.

23. The apparatus of claim 12 wherein the fuel to be desulfurized is a diesel fuel.
